(19) United States
(12) Patent Application Publication
(10) Pub. No.: US 2024/0281813 A1
(43) Pub. Date: Aug. 22, 2024

(54) REAL-TIME CROSS-CHANNEL VERIFICATION

(71) Applicant: Bank of America Corporation, Charlotte, NC (US)

(72) Inventors: Indradeep Dantuluri, Harrisburg, NC (US); Pavan Chayanam, Alamo, CA (US)

(21) Appl. No.: 18/110,461

(22) Filed: Feb. 16, 2023

(51) Int. Cl. G06Q 20/40; G06Q 20/32

(52) U.S. Cl. CPC G06Q 20/4016; G06Q 20/3255; G06Q 20/326

(57) ABSTRACT

Systems, methods, and apparatus are provided for verification of a communication across communication channel technologies. A secure mobile device application may authenticate a user and launch a background application. The background application may interact with multiple different communication channels, such as an email application and an SMS application. The background application may scan a communication received at one of these channels for a security marker. When the security marker is not present, the mobile device application may display an alert associated with the communication. The scan may be limited to ensure the privacy of the communication content. The scan parameters may be configured at the mobile device application.

### FIELD OF TECHNOLOGY

Aspects of the disclosure relate to mobile applications for use with mobile devices.

### BACKGROUND OF THE DISCLOSURE

An enterprise may interact with a customer through a variety of channels. For example, the enterprise may communicate by chat through a mobile application, by text message, or by email. Each medium may be protected with different modes of security.

For example, text-based fraud activity has become commonplace, with bad actors posing as representatives of legitimate financial institutions. Mobile device applications, on the other hand, are typically highly secured, often with both password and biometric verification. However, customer-facing mobile applications typically use different protocols and technologies from channels such as text and email.

An omnichannel approach may enable an enterprise to provide an integrated experience across multiple channels. It would be desirable to leverage the security features of a mobile application to verify authenticity of communications via alternate channels such as text and email messaging.

### SUMMARY OF THE DISCLOSURE

Systems, methods, and apparatus are provided for cross-channel verification of a communication.

At a mobile device, a background application may interact with multiple communication channels. The background application may be launched from a secure mobile device application. The background application may be launched in response to authenticating a device user at the mobile application.

The background application may scan a communication received at a communication channel, such as an email application or SMS application, to identify a security marker included in the communication. The scan may be limited to text or logo matching.

When the security marker is not present, an alert associated with the communication may be displayed at the mobile application. When the security marker is present, a cleared notice may be associated with the communication at the mobile application.

The invention is a practical application that integrates a biometrically secured mobile application with SMS and email messaging technologies. The secure mobile application may launch a lightweight background application that verifies communications across channels. Scan parameters may be controlled at the secure mobile application. System architecture may manage interfaces between front-end and back-end applications to authenticate communications in real-time.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows illustrative apparatus in accordance with principles of the disclosure;

FIG. 2 shows illustrative apparatus in accordance with principles of the disclosure;

FIG. 3 shows a set of illustrative screen views in accordance with principles of the disclosure;

FIG. 4 shows an illustrative process flow in accordance with principles of the disclosure;

FIG. 5 shows an illustrative process flow in accordance with principles of the disclosure.

FIG. 6 shows an illustrative process flow in accordance with principles of the disclosure;

FIG. 7 shows an illustrative process flow in accordance with principles of the disclosure; and

FIG. 8 shows an illustrative process flow in accordance with principles of the disclosure.

### DETAILED DESCRIPTION

Systems, methods, and apparatus are provided for cross-channel verification.

For the sake of illustration, the invention will be described as being performed by a “system.” The system may include one or more features of apparatus and methods that are described herein and/or any other suitable device or approach.

An enterprise may maintain multiple different customer-facing channels, each relying on different technologies. Different channels may include different levels of security.

For example, a mobile application may require biometric authentication. Within the mobile application, a customer may feel secure that they are interacting with legitimate enterprise representatives. However, a text message typically does not provide any way for an agent to authenticate themselves as a legitimate representative.

Text messages may be referred to as Short Message Service (SMS). SMS is a text messaging component of mobile device systems. SMS applications use standardized communication protocols for transmission of short text messages.

It would be desirable to provide a system for leveraging more secure channels, such as an enterprise mobile device application, for verification of communications received via SMS or email.

The system may include a secure mobile device application. The mobile device application may require any suitable form of user authentication. The authentication may include two-step verification. The authentication may include a one-time PIN. The authentication may include biometric authentication.

The system may include a web servicing application. The web servicing application may be a server-based intermediary serving front-end channels. The web servicing application may act as a gateway between the mobile device and back-end enterprise systems. The gateway may be an internal enterprise application that exposes web services to the mobile application. The gateway may provide user authentication and protection for enterprise systems.

The mobile device application may access the web servicing application. In some embodiments, the mobile application may use a WebSocket connection to access the web servicing application. WebSocket protocols may enable interaction between a client application and a web server using a bidirectional binary protocol. A protocol handshake may pass data to an application using Hypertext Transfer Protocol (HTTP) and may enable a server to manage HTTP and WebSocket connections on the same port. WebSocket communication protocols are typically used for chat functions.

In some embodiments, the web servicing application may be a java-based representational state transfer (REST) application. REST is a software architecture that defines the constraints to create web services.

The web servicing application may interact with back-end system components such as a multi-channel communication server and a secure database.

The web servicing application may provide web services or WebSocket services to mobile application. The web servicing application may include functionalities for interfacing with data related to transfers, deposits, or accounts. Functionalities for interfacing with data related to a security marker may be included as an additional component to an existing web servicing framework.

The system may include a security application server. The security application may be a function of a web servicing application. The security application server may process a security marker such as a passphrase that is configured or displayed at the mobile application.

The system may include a security marker. The security marker may be a visual cue. The security marker may be text-based. The security marker may be alphanumeric. The security marker may include a graphic image such as a logo or a photograph. The security marker may be a passphrase.

In some embodiments the security marker may be configured by a user. For example, a passphrase may be entered at the mobile device application and processed by the security application server.

The system may include a secure enterprise database. The database may store the passphrase in association with a user account identifier.

The system may include a multi-channel communication server. The multi-channel communication server may retrieve the passphrase from the secure enterprise database. The multi-channel communication server may interface with different enterprise communication technologies.

The multi-channel communication server may transmit the passphrase to an SMS engine. The SMS engine may generate an SMS communication to the user. The SMS communication may include the passphrase. The passphrase may serve as a visual cue to the user to confirm the authenticity of the SMS communication.

The multi-channel communication server may transmit the passphrase to an email engine. The email engine may generate an email communication to the user. The email communication may include the passphrase. The passphrase may serve as a visual cue to the user to confirm the authenticity of the email communication.

After receiving a communication including the passphrase, the customer user may also verify the communication at the mobile application. The mobile application may display the passphrase.

In some embodiments, the mobile application may display a communication log. The communication log may record enterprise SMS and/or email communications that were transmitted to the user. The communication log may include a time of transmission for each communication. In some embodiments, the communication log may include a subject or topic for associated with each communication.

In some embodiments, a security passphrase may be configured by the system. The passphrase may be generated at the mobile application. The passphrase may be generated by the multi-channel communication server. The secure enterprise database may store the passphrase in association with a customer account identifier. The multi-channel communication server may interface with different communication technologies, such as SMS messaging and email, as described above.

The secure application server may transmit the passphrase to the mobile application. In response to user login and authentication, the mobile application may display the system-generated passphrase to the customer to verify communications transmitted via other channels.

In some embodiments, the mobile application may actively verify communications via other channels. The mobile application may launch a background application. Background applications typically have no direct user interface and may run continuously once launched. In some cases, if a background application crashes, the system may automatically restart the background application.

The background application may interact with different communication channels. For example, the background application may interact with an email application. The background application may interact with an SMS application.

The background application may be a lightweight application. Lightweight applications typically require less storage space and processing power. This may enable the background application to run without decreasing device battery life or impacting other processes.

The background application may be launched automatically in response to customer login and authentication at the mobile application. The background application may be launched via a selectable option displayed in the mobile application.

The background application may verify a communication by matching a security marker present in the communication to a stored security marker. If the security marker is not present or does not match the stored security marker, the background application may flag the communication as fraudulent. If the security marker is present in the communication, the background application may mark the communication as cleared. The match may be a percentage match that exceeds a predetermined threshold.

The background application may be limited to interaction with an email application. The background application parameters may be restricted to protect the privacy of email content. For example, the background application may be limited to scans of email header data. The background application may be limited to matching the text of the security passphrase in the body of the email or in the email signature. The background application may be limited to image matching for a visual security cue. In some embodiments, the visual cue may be an enterprise logo. The parameters of the scan may be configured using selectable options displayed in the mobile application.

The background application may be limited to interaction with an SMS messaging application. The background application parameters may be restricted to ensure privacy of SMS content. The background application may be limited to matching the security passphrase in the body of the SMS message. The background application may be limited to image matching for a visual security cue. In some embodiments, the visual cue may be an enterprise logo. The parameters of the scan may be configured using selectable options displayed in the mobile application.

In response to a determination that the security marker is not present in a communication, the background application may take actions to protect against fraud. In some embodiments, a user account associated with the mobile application may be temporarily locked. In some embodiments the background application may disable any links present in the communication. This measure may prevent a customer from compromising device security by activating the link.

The background application may interact with the secure enterprise mobile application. In some embodiments a fraud alert may be displayed at the mobile application. In some embodiments, the mobile application may push a fraud alert to the user. The mobile application may include a communication log. A communication that does not include the security marker may be listed in the communication log as a fraud risk. A communication that includes the security marker may be listed in the communication log as cleared.

In some embodiments, a user may use a mobile application chat interface to communicate an inquiry regarding a communication to the enterprise. The user may communicate with a live agent or with an interactive response system. The interactive response system may include a chatbot. Chatbots are software used to automate conversations and interact with humans through various communication platforms. Chatbots may be powered by pre-programmed responses, AI and/or machine learning in order to answer questions without involving a human agent. Chatbots may simulate conversations with a human using text, text-to-speech, or speech-to-speech.

A user may inquire about the legitimacy of an email or SMS communication. The interactive response system may communicate with the multi-channel communication server. The interactive response system may transmit information about a communication to the user.

One or more non-transitory computer-readable media storing computer-executable instructions are provided. When executed by a processor on a computer system, the instructions perform a method for integrating real-time verification across multiple enterprise channels.

The method may include, authenticating a user at a first communication channel. The first communication channel may be a mobile device application.

The method include may launching a background application. The background application may be configured to interact with the first communication channel and with a second communication channel. The background application may be launched in response to user authentication at the first channel. The background application may be launched in response to a user input input selecting an option displayed at the first channel.

The background application may scan a communication received at the second communication channel for a security marker. When the security marker is not present, the first communication channel may display an alert associated with the communication. When the security marker is present, the first communication channel may display a cleared status for the communication.

When the security marker is not present, the background application may lock a user account. When the security marker is not present, the background application may disable a link present in the communication.

Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional, and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods. Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

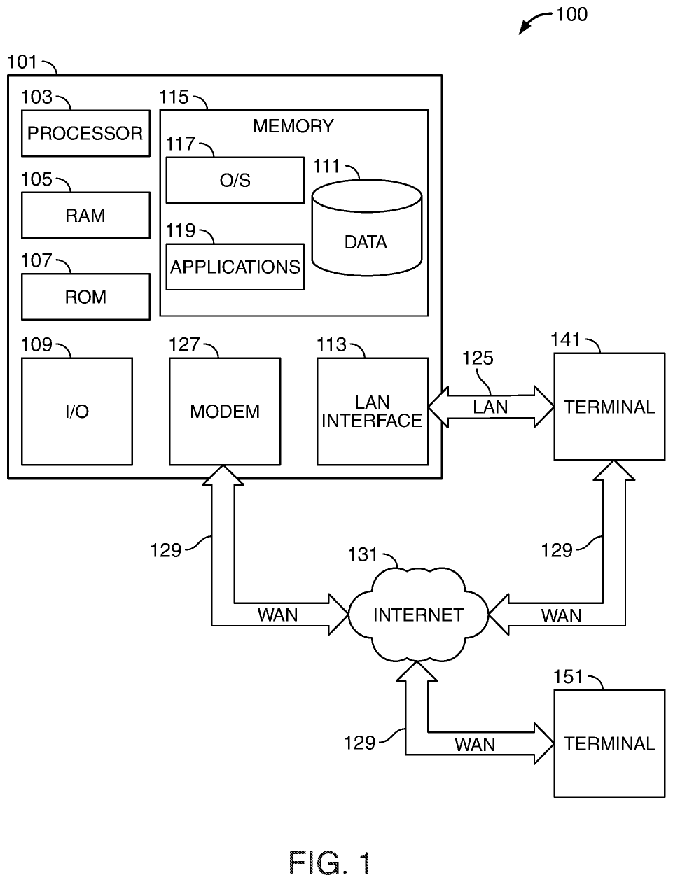

FIG. 1 shows an illustrative block diagram of system 100 that includes computer 101. Computer 101 may alternatively be referred to herein as an “engine,” “server,” or a “computing device.” Computer 101 may be a workstation, desktop, laptop, tablet, smartphone, or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may have a processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. The processor 103 may also execute all software running on the computer. Other components commonly used for computers, such as EEPROM or flash memory or any other suitable components, may also be part of the computer 101.

Memory 115 may be comprised of any suitable permanent storage technology, such as a hard drive. Memory 115 may store software including the operating system 117 and application program (s) 119 along with any data 111 needed for the operation of the system 100. Memory 115 may also store videos, text, and/or audio assistance files. The data stored in memory 115 may also be stored in cache memory, or any other suitable memory.

I/O module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 is connected to LAN 125 through LAN interface 113 or an adapter. When used in a WAN networking environment, computer 101 may include modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (API). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program (s) 119 (which may be alternatively referred to herein as “plugins,” “applications,” or “apps”) may include computer executable instructions for invoking functionality related to performing various tasks. The computer executable instructions may be embodied in hardware or firmware (not shown). Application program (s) 119 may utilize one or more algorithms that process received executable instructions, perform power management routines or other suitable tasks. Application program (s) 119 may utilize one or more decisioning processes for the processing of real-time communications as detailed herein.

Application program(s) 119 may utilize the computer-executable instructions executed by a processor. Generally, programs include routines, programs, objects, components, data structures, etc., that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

The invention may be described in the context of computer-executable instructions, such as application (s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone, or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

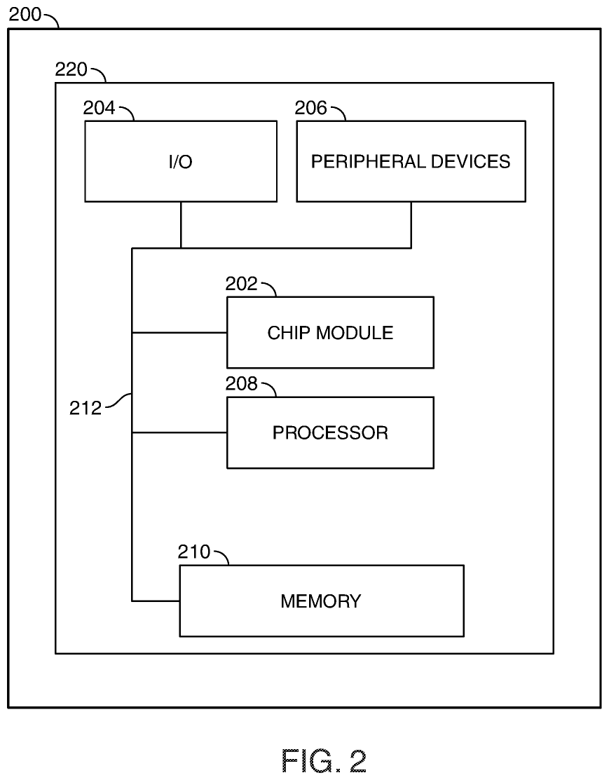

FIG. 2 shows illustrative apparatus 200 that may be configured in accordance with the principles of the disclosure. Apparatus 200 may be a computing device. Apparatus 200 may include one or more features of the apparatus shown in FIG. 2. Apparatus 200 may include chip module 202, which may include one or more integrated circuits, and which may include logic configured to perform any suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208, and 210 may be coupled together by a system bus or other interconnections 212 and may be present on one or more circuit boards such as circuit board 220. In some embodiments, the components may be integrated into a single chip. The chip may be silicon-based.

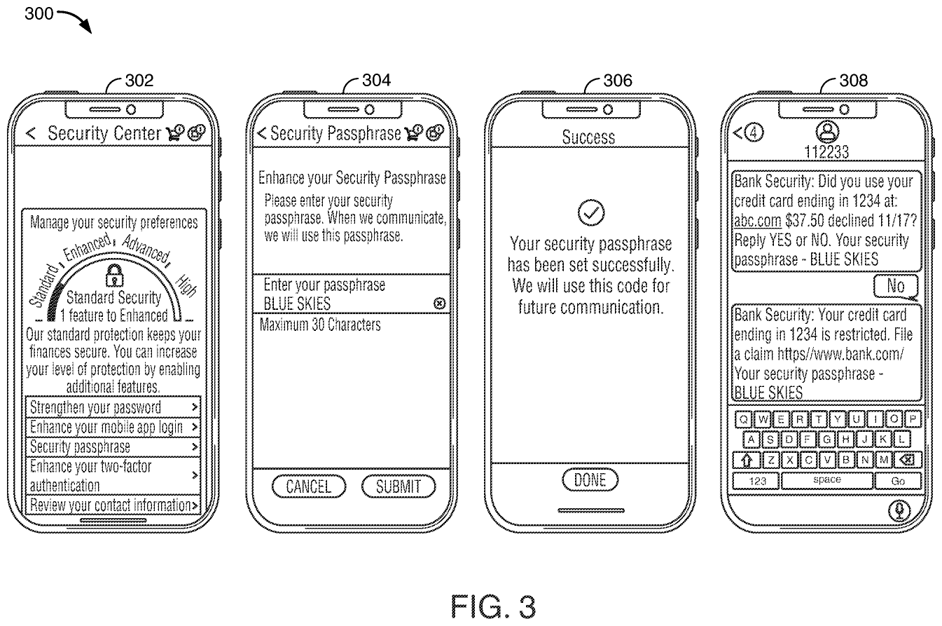

FIG. 3 shows illustrative screen views 300. Illustrative screen views 300 show security screens 302-306 associated with a financial institution mobile device application, and message screen 308 associated with an SMS application.

Screens 302-306 show configuration of a security marker by a user at the mobile device application. Various illustrative screen designs are shown, but any suitable display or arrangement may be used. Screen 302 shows various selectable options for security enhancements. At screen 304, a user has selected the option for a security passphrase. Screen 304 shows entry of an illustrative passphrase. Screen 306 shows that the security passphrase has been configured successfully. Screen 308 shows illustrative text messages from the financial institution that are received at a separate SMS application. The illustrative messages include the security passphrase configured by the user in the mobile application.

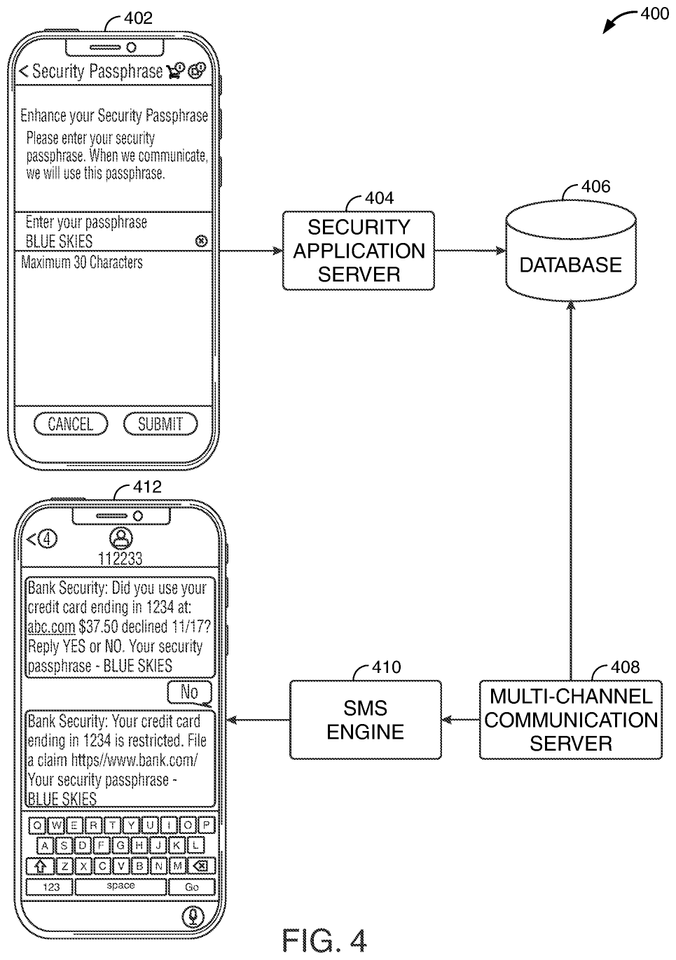

FIG. 4 shows illustrative process flow 400 for cross-channel verification of a communication using a security marker. At 402, a user configures a security passphrase in a mobile application. Screen view 402 may correspond to screen view 304, shown in FIG. 3. At 404, a security application server may process the security passphrase. At 406, the security passphrase may be stored in a customer database in association with a user account.

At 408, a multi-channel communication server may initiate a communication for transmission via SMS. The multi-channel communication server may retrieve the security passphrase from the database. At 410, an SMS engine may generate a message that includes the security passphrase. At 412, the message may be received at an SMS application on a user device. Screen view 412 may correspond to screen view 308, shown in FIG. 3.

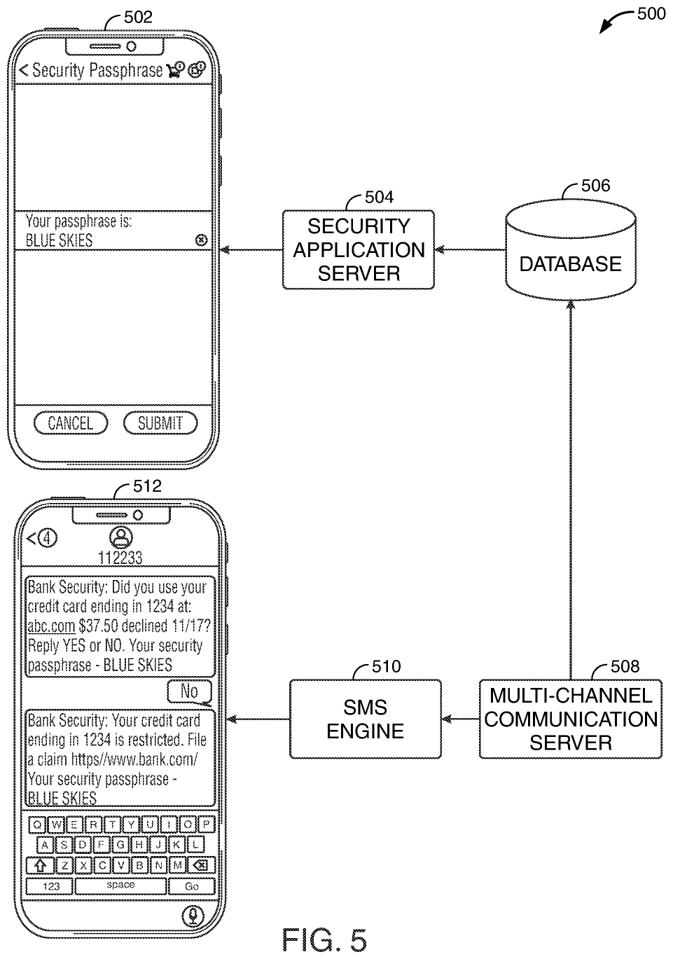

FIG. 5 shows illustrative process flow 500 for cross-channel verification of a communication using a security marker. Elements of process flow 500 may correspond to elements of process flow 400, shown in FIG. 4.

At 508, a multi-channel communication server may autogenerate a security passphrase for a user. At 506, the security passphrase may be stored in a customer database in association with a user account.

The multi-channel communication server may initiate a communication for transmission via SMS. The multi-channel communication server may retrieve the security passphrase from the database. At 510, an SMS engine may generate a message that includes the security passphrase. At 512, the message may be received at an SMS application on a user device.

At 504, a security application server may interface with an enterprise mobile application at the user device and transmit the security passphrase. At 502, the user may view the system-generated passphrase at the mobile application to verify the communication received via SMS.

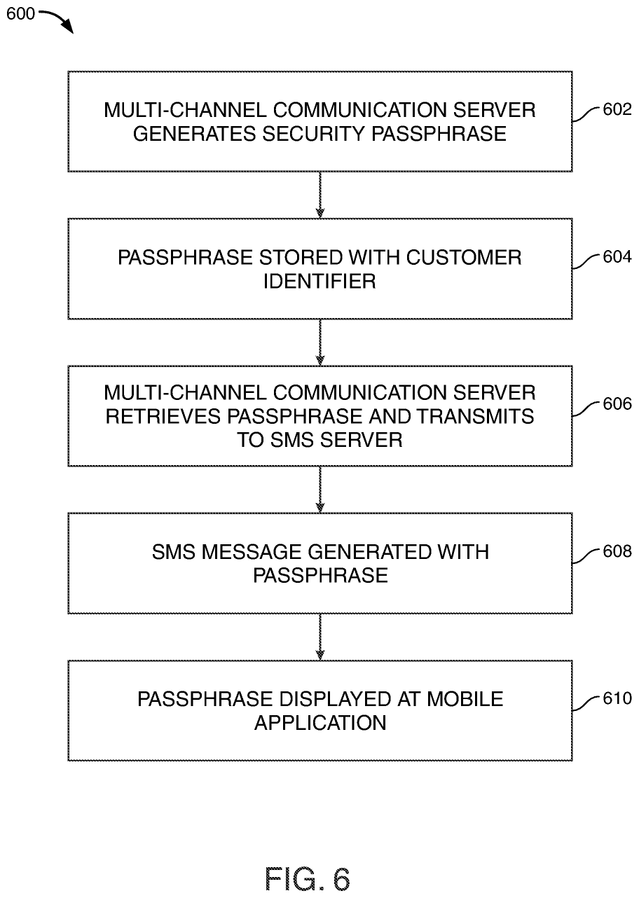

FIG. 6 shows illustrative process flow 600. Process flow 600 shows cross-channel verification using a security marker.

At step 602, a multi-channel communication server generates a security passphrase. At step 604, the passphrase is stored in association with a customer identifier such as an account number.

At step 606, the multi-channel communication server retrieves the passphrase and transmits it to an SMS server. At step 608, the SMS server generates a message that includes the passphrase. At step 610, the passphrase is displayed to the customer at a separate mobile application for verification of the SMS message.

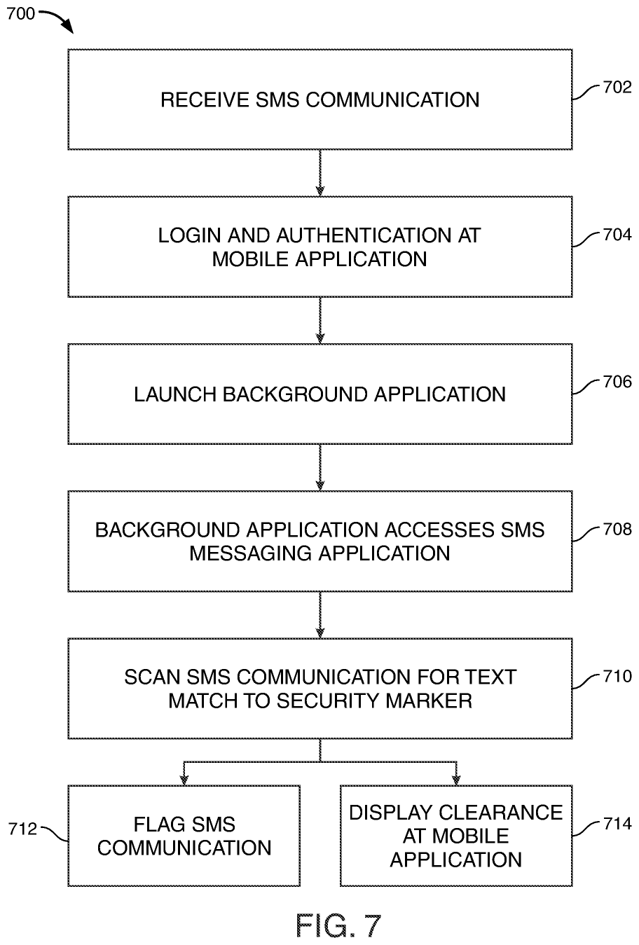

FIG. 7 shows illustrative process flow 700 for cross-channel verification using a security marker. At step 702, a user receives an SMS communication at an SMS channel. At step 704, the user may log in and authenticate themself at a separate mobile application.

At step 706, the mobile application may launch a background application that runs on the mobile device. At step 708, the background application interfaces with the SMS channel. At step 710, the background application scans the SMS communication to match the security marker with a stored marker. At step 712, if the markers do not match, the SMS communication is flagged. At step 714, if the markers match, the SMS communication is cleared. The flag and the clearance may be displayed at the mobile application.

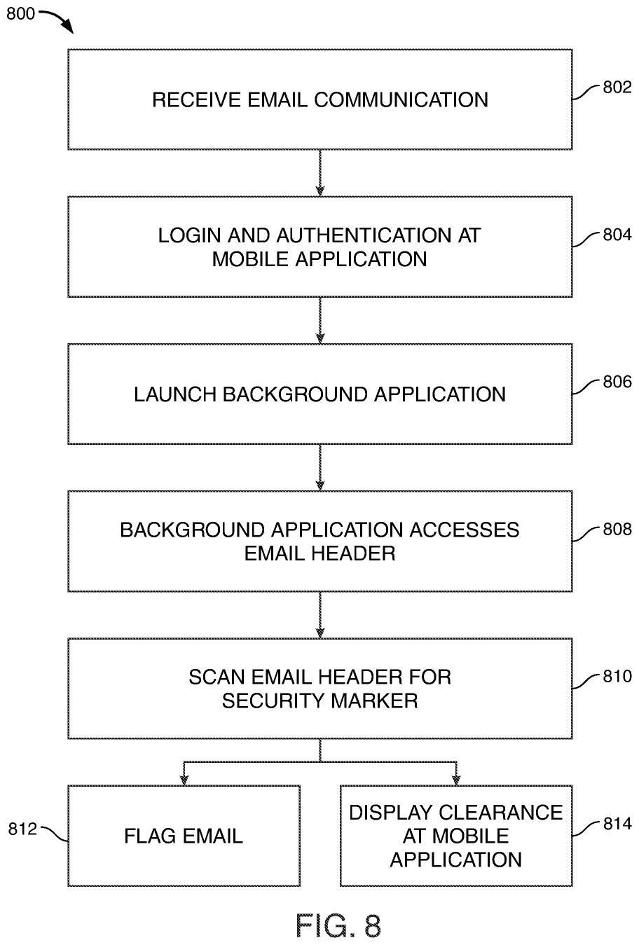

FIG. 8 shows illustrative process flow 800 for cross-channel verification using a security marker. At step 802, a user receives an email communication at an email channel. At step 804, the user may log in and authenticate themself at a separate mobile application.

At step 806, the mobile application may launch a background application that runs on the mobile device. At step 808, the background application interfaces with the email channel. At step 810, the background application scans the email communication to match the security marker with a stored marker. At step 812, if the markers do not match, the email communication is flagged. At step 814, if the markers match, the email communication is cleared. The flag and the clearance may be displayed at the mobile application.

Thus, methods and apparatus for REAL-TIME CROSS-CHANNEL VERIFICATION are provided. Persons skilled in the art will appreciate that the present invention can be practiced by other than the described embodiments, which are presented for purposes of illustration rather than of limitation, and that the present invention is limited only by the claims that follow.

What is claimed is:

1. A method for cross-channel verification of a communication, the method comprising:
at a mobile device, launching a background application, the background application configured to interact with an SMS application and an enterprise mobile application;
at the background application, scanning a communication received at the SMS application for a security marker;
when the security marker is not present, displaying an alert associated with the communication at the enterprise mobile application; and
when the security marker is present, displaying a cleared notice associated with the communication at the enterprise mobile application.

2. The method of claim 1, further comprising, launching the background application in response to authentication of a mobile device user at the enterprise mobile application.

3. The method of claim 1, further comprising, displaying a selectable option at the enterprise mobile application to launch the background application.

4. The method of claim 1, wherein a scan at the background application is limited to matching a visual cue.

5. The method of claim 4, wherein the visual cue is a security passphrase.

6. The method of claim 1, the communication received at the SMS application comprising a first communication, the background application further configured to interact with an email application, the method further comprising:
at the background application, scanning a second communication received at the email application for the security marker;
when the security marker is not present, displaying an alert associated with the second communication at the enterprise mobile application; and
when the security marker is present, displaying a cleared notice associated with the second communication on a communication log at the enterprise mobile application.

7. The method of claim 6, further comprising limiting the scan of the second communication to an email header.

8. The method of claim 1, further comprising, when the security marker is not present, locking a financial account associated with a user of the mobile device.

9. The method of claim 1, further comprising, when the security marker is not present, disabling a selectable link in the communication.

10. A method for cross-channel verification, the method comprising:
at a first communication channel:
authenticating a customer;
in response to the authentication, launching a background application, the background application configured to interact with the first communication channel and a second communication channel;
at the background application, scanning a communication received at the second communication channel for a security marker;
when the security marker is not present, displaying an alert associated with the communication at the first communication channel; and
when the security marker is present, displaying a cleared status for the communication at the first communication channel.

11. The method of claim 10, further comprising:
receiving input of a security marker at the first communication channel;
storing security marker in association with a user account; and
at a multi-channel communication server:
accessing the security marker;
transmitting a communication comprising the security marker via the second communication channel.

12. The method of claim 10, further comprising:
autogenerating a security marker at the first communication channel;
storing the security marker in association with a customer account; and
at a multi-channel communication server:
accessing the security marker;
transmitting a communication comprising the security marker via the second communication channel.

13. The method of claim 10, the background application configured to interact with a third communication channel, the method comprising:
at the background application, scanning a communication received at a third communication channel for the security marker;
when the security marker is not present, displaying an alert associated with the communication at the first communication channel; and
when the security marker is present, displaying a cleared status for the communication at the first communication channel.

15. The method of claim 10, further comprising, displaying a selectable option at the first communication channel to launch the background application.

16. One or more non-transitory computer-readable media storing computer-executable instructions which, when executed by a processor on a computer system, perform a method for integrating real-time verification across multiple enterprise channels, the method comprising:
at a first communication channel comprising a mobile device application:
authenticating a user;
launching a background application, the background application configured to interact with the first communication channel and a second communication channel;
at the background application, scanning a communication received at the second communication channel for a security marker;
when the security marker is not present, displaying an alert associated with the communication at the first communication channel; and
when the security marker is present, displaying a cleared status for the communication at the first communication channel.

17. The media of claim 16, further comprising launching the background application in response to authentication of the user at the first communication channel.

18. The media of claim 16, further comprising displaying a selectable option at the first communication channel to launch the background application.

19. The media of claim 16, further comprising, when the security marker is not present, locking a financial account associated with the user.

20. The media of claim 16, further comprising, when the security marker is not present, disabling a link in the second communication.
